(19) United States
(12) Patent Application Publication
(10) Pub. No.: US 2002/0054373 A1
(43) Pub. Date: May 9, 2002

(54) Device, system, method, and program for image data handling, and device for image processing

(76) Inventor: Junichi Nishiyama, Atsugi-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/895,402

(22) Filed: Jul. 2, 2001

(30) Foreign Application Priority Data
Jul. 6, 2000 (JP) 2000-205234

(51) Int. Cl. H04N 1/387

(52) U.S. Cl. 358/452

(57) ABSTRACT

An image processing device including an image reader for reading a document image, a detector for detecting a reading condition in reading the document image, an extractor for extracting a specific image data from the image data, a generator for generating an index data including the specific image data and the reading condition data, and a printer for printing the index data.

This application is based on Japanese Patent Application No. 2000-205234 filed on Jul. 6, 2000, the contents of which are hereby incorporated by reference.

### BACKGROUND OF THE INVENTION

1. Field of the Invention

The present invention relates to an image processing device, an image processing method and a computer-readable storage medium for processing image data generated by reading document image.

2. Description of Related Art

The use of a copying machine with image reading and printing capabilities as a scanner and a printer has been known. When a copying machine and a computer are connected via a network, they are often installed apart.

In such a case, it is necessary for the user to go back and forth between the copying machine and the computer in order to set the document on the scanner of the copying machine and instruct the reading from the computer, which is a problem as it is time consuming.

One possible way to solve this problem is to store the image data of the document in the hard disk (HDD) and a file server and retrieve it later from the computer for usage.

The image data is given a name automatically when it is stored into the storage device. Since the file name consists of numbers or date data, it is difficult to remember. Thus, the user may forget the file name and may not be able to use a specific image data after a certain time.

On the other hand, it is possible to give a unique and identifiable name to an image data manually. However, such a method has a problem that it increases the user's workload.

Moreover, it is difficult to select the necessary image data efficiently as it is impossible to recognize the content of the image data or the reading condition data from the image data's name. In other words, since it is difficult to identify the image data, it leaves a problem in the efficiency in using the image data.

### SUMMARY OF THE INVENTION

It is therefore a general object of the present invention to provide an image processing technology for easily identifying image data stored in the storage device without causing any increase of workload.

More specifically, it is an object of the invention to provide an image processing device including an image reader for reading a document image, a detector for detecting a reading condition in reading the document image, an extractor for extracting a specific image data from the image data, a generator for generating an index data including the specific image data and the reading condition data, and a printer for printing the index data.

Also an object of the invention is to provide an image data handling system including an image input device and a printing device. The image input device includes an image reader for reading a document image, a detector for detecting a reading condition in reading the document image, an extractor for extracting a specific image data from the image data, a generator for generating an index data including the specific image data and the reading condition data, and a transmitting device for transmitting the index data to the printing device. On the other hand, the printing device includes a receiving device for receiving the index data and a printer for printing the received index data.

A further object of the invention is to provide an image data handling system including an image input device and a data processing device. The image input device includes an image reader for reading a document image, a detector for detecting a reading condition in reading the document image, a transmitting device for transmitting the read image data and the reading condition data to the data processing device, and a printer for printing the data. On the other hand, the data processing device includes a receiving device for receiving the data, an extractor for extracting a specified image data from the received image data, a generator for generating an index data including the specified image data and the reading condition data, and a transmitting device for transmitting the generated index data to the image input device.

A further object of the invention is to provide an image data handling method for handling an image data acquired by reading a document image. The image data handling method includes the steps of acquiring the read image data, acquiring a reading condition data of the document image, extracting a specific image data from the image data, generating an index data including the specific image data and the reading condition data, and issuing instructions to print the index data.

A further object of the invention is to provide a program for executing the image data handling method.

A further object of the invention is to provide an image data handling device including an input device for inputting an image data; a storage device for storing the inputted image data; a generating device for generating an index data by acquiring a generating condition when the image data is generated, generating reduced image data of the image data, and combining the generating condition and the reduced image data; and an output device for outputting the generated index data.

The objects, characteristics, and advantages of this invention other than those set forth above will become apparent from the following detailed description of the preferred embodiments, which refers to the annexed drawings.

### BRIEF DESCRIPTION OF THE DRAWINGS

FIG. 1 is a block diagram of assistance in explaining a digital copying machine as an image processing device according to a first embodiment of the invention;

FIG. 2 is a flowchart of the CPU's control of the digital copying machine;

FIG. 3 is a plan view showing an example image on a display unit of the digital copying machine;

FIG. 4 illustrates an example document consisting of multiple pages;

FIG. 5 illustrates an example output of an index data outputted from the digital copying machine;

FIG. 6 illustrates a modification of the output of the index data;

FIG. 7 illustrates another modification of the output of the index data;

FIG. 8 is a block diagram of assistance in explaining the system structure of an image processing device according to the second embodiment;

FIG. 9 is a block diagram of assistance in explaining the system structure of an image processing device according to the third embodiment;

FIG. 10 is a block diagram of assistance in explaining the system structure of an image processing device according to the fourth embodiment; and

FIG. 11 is a flowchart of the CPU's control of the image processing device.

### DETAILED DESCRIPTION OF THE EMBODIMENTS

The embodiments of this invention will be described below with reference to the accompanying drawings.

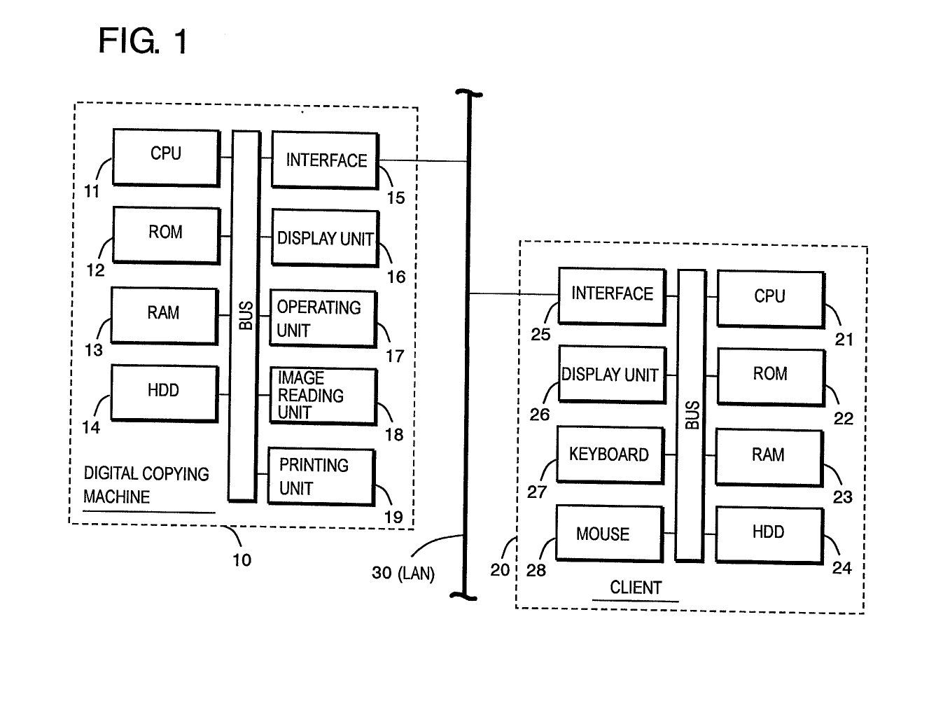

A digital copying machine 10 shown in FIG. 1 is an image processing device according to the first embodiment, and is connected to a local areas network (LAN) 30. A client 20 is also connected to the LAN 30.

The digital copying machine 10 includes a central processing unit (CPU) 11, a first storage device (ROM) 12, a second storage device (RAM) 13, a third storage device (HDD) 14, an interface 15, a display unit 16, a operating unit 17, an image reading unit 18, and a printing unit 19, all of which are interconnected via a bus. The digital copying machine 10 has a capability of a file server, and the image data stored in the HDD 14 can be used by the client.

The ROM 12 is a read-only storage device, and stores a program for executing an image processing method for processing image data acquired by reading document images. The detail of the image processing method will be described later.

The RAM 13 is a high-speed random access storage device, and is used as a temporary work area for executing the image processing program. The HDD 14 is a large capacity random access storage device, which is shared by other computers connected to the LAN, and is used for storing image data temporarily.

The display unit 16 is equipped with a liquid crystal display panel to display various messages. The operating unit 17 has multiple keys and a touch panel to be arranged on the liquid crystal display panel, which are used for entering information for various setting items of the digital copying machine 10.

The image reading unit 18 is equipped with an automatic document feeder (ADF) for feeding documents to the reading position automatically.

The interface 15 is equipped with a network interface card and is used for transmitting image data to the client 20 via the network 30.

The client 20 is a computer such as a PC or a workstation and includes a central processing unit (CPU) 21, a first storage device (ROM) 22, a second storage device (RAM) 23, a third storage device (HDD) 24, an interface 25, a display unit 26, a keyboard 27, and a mouse 28, all of which are interconnected via a bus.

The ROM 22 is a read-only storage device and stores basic programs such as the BIOS (basic input/output system). The RAM 23 is a high-speed random access storage device and is temporarily used as a work area for executing the programs. The HDD 24 is a high-capacity random access storage device and stores the operating system, application programs, data, etc.

The interface 25 has a network interface card and is used for receiving image data from the digital copying machine 10 via the network 30.

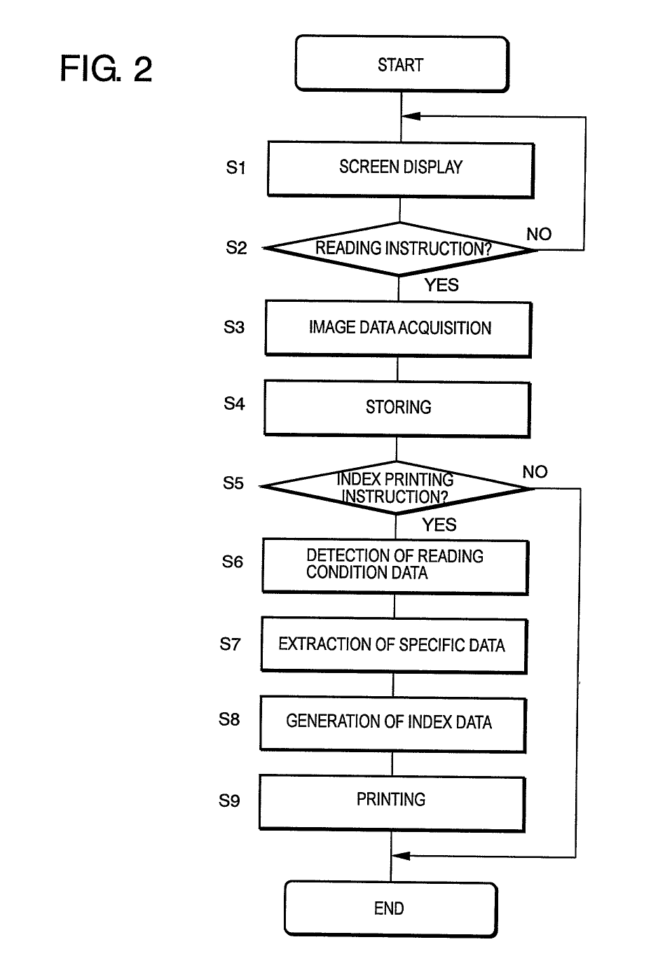

Next, the control of the CPU 11 based on the image processing method of the program stored in the ROM 22 will be described referring to the flowchart of FIG. 2.

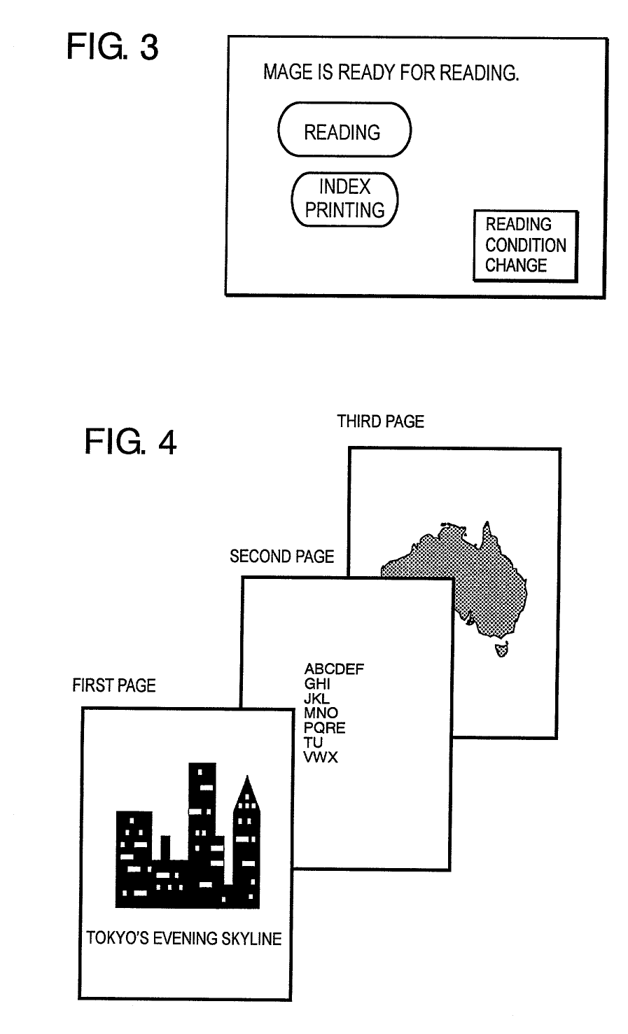

First, as shown in FIG. 3, the display unit 16 displays a prompting message for the user to instruct either image reading, index printing, or reading condition change (step S1). After that, a judgment is made whether there is a reading instruction based on the signal from the touch panel corresponding to the display position of the message “reading” (step S2). When it is judged that there is no reading instruction, the process returns to the step S1, and the waiting operation is continued. When the reading instruction is detected, the image reading unit 18 is controlled, and the document image data is acquired (step S3). The image data is given a name automatically and stored into the HDD 14 (step s4).

Next, the display shown in FIG. 3 appears on the display unit 16 again, and a judgment is made whether there is an index printing instruction based on the signal from the touch panel corresponding to the position the message “index printing” is placed (step S5). If it is judged that there is no index printing instruction, the process terminates.

If an index printing instruction is detected, the reading condition data at the image reading unit 18 is detected (step S6). The reading condition data includes document size, number of pages, reading mode, resolution, and image quality data, and it is possible to use all or one of these data. The reading mode can be the color mode for processing the document image as a color image or the monochromatic mode for processing the document image as a monochromatic image. There are three types of image quality data, i.e., photographic data, line drawing data, or character data.

It is also possible to include the file name and destination data of the image data in the reading condition data. The destination data includes the name of equipment containing the storage device where the image data is stored, the directory name where the file is located in the storage device, and the file name.

Next, the specific data is extracted from the image data stored in the HDD 14 (step S7). The specific data is the image data of the specific page of the document (detail to be described later). Then, index data including the image data of the specific page, the reading condition data, and the data concerning the image data file is generated (step S8). After that, the printing unit 19 is controlled, the index data is printed (step S9), and the process is completed.

Next, using an A4 size document consisting of three pages shown in FIG. 4 as an example, the index data to be printed will be described below. The image on the first page is a graphic data showing Tokyo's evening skyline, the image on the second page is a character data, and the image on the third page is a graphic data of the map of Australia.

The reading of the document can be handled by treating the multiple image data that are to be continuously read by the ADF provided at the image reading unit 18 as one document.

As to the reading condition, let it be supposed that the reading mode is “color,” the resolution (unit is dpi) is “600,” and the image quality data is “photographic,” the name of the digital copying machine 10 as a file server is “copier01,” the directory name is “guest,” and the file name is “doc1.tif.” Thus, the destination data is, for example, “//copier01/guest/doc1.tif.”

In addition to the above, it is also possible to treat each page as a separate file and store the files in one directory. As the format of the image data file, Multipage TIF Format, etc., can be used which allow us to treat multiple pages of images as one file.

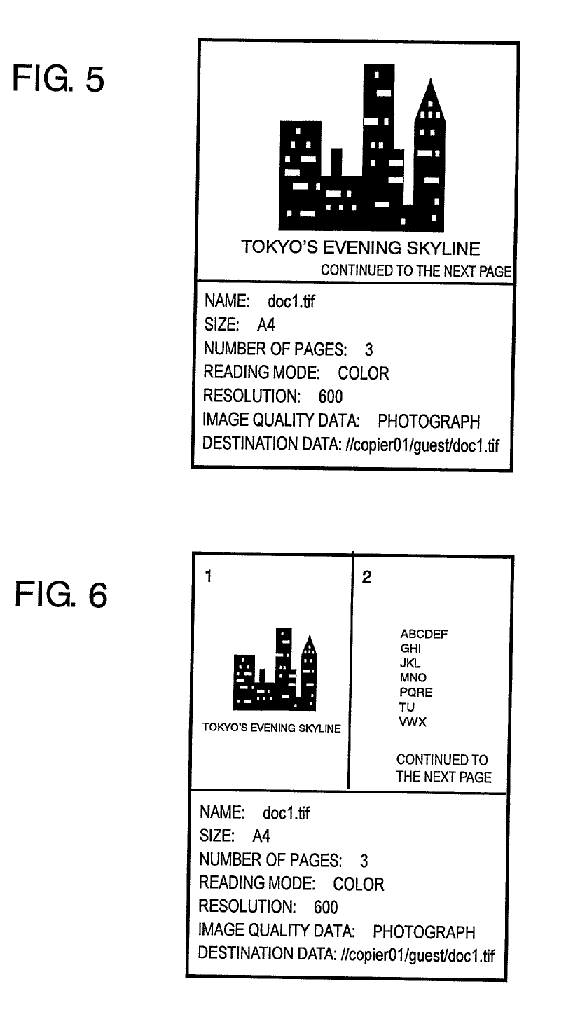

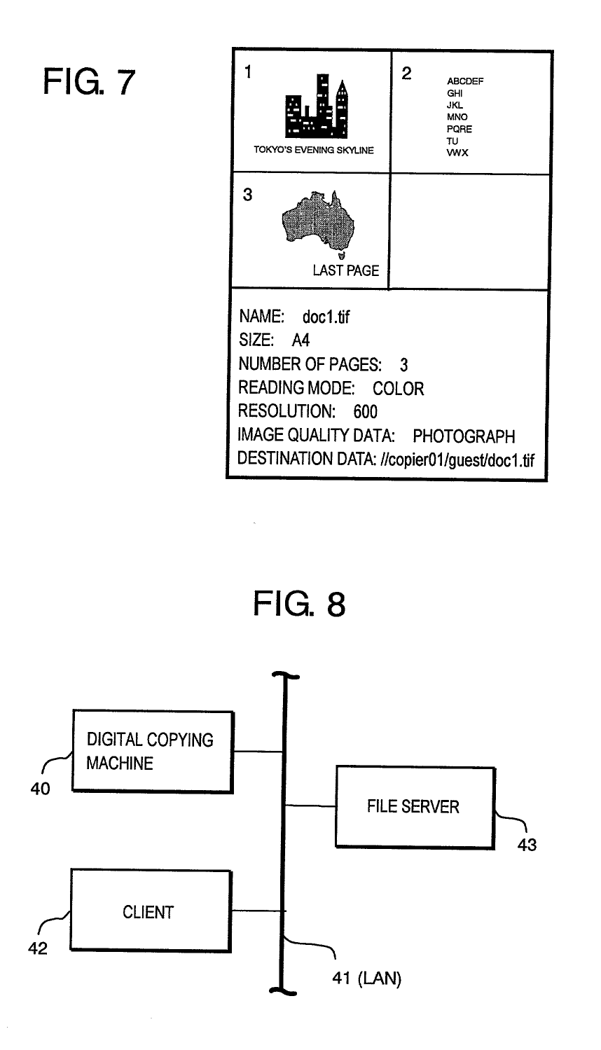

When the first page image is uses as a specific data, the index data shown in FIG. 5 will be printed. It should be noted here that the note data that there is a next page is added to the reduced image of the first page. It is also possible to use a specific range of image data, e.g., the reduced images of the first and second page as shown in FIG. 6, as the specific data. In this case, the note data that there is a next page is added to the last reduced image. Moreover, it is also possible to use the reduced images of all pages as the specific data as shown in FIG. 7. In this case, the note data that there is no next page is added to the reduced image on the last page.

If multiple pages of images are used as the index data, the reduction rate of the image becomes too large compared to the case of using the first page image only, and the image identification quality reduces. However, it is effective if the first page image is not representative of the entire content.

The user identifies the necessary image data stored in the HDD 14 based on the index data, and acquires the data using the client 20.

As can be seen, the user's workload does not increase, as the index data are automatically generated and printed. Moreover, the index data contains the reading condition data including the file name and the destination data of the image data, and the content data of the image data. Thus, it is possible to easily identify the image data and efficiently select the image data even after a lapse of some times. In other words, it makes it easy to identify the image data stored in the storage device without increasing the workload.

Next, the variations of the first embodiment will be described.

It is possible to specify the destination data without being limited by the abovementioned description format, for example, by means of URL (uniform resource locator) More specifically, the destination data is constituted with “transfer protocol/domain name/directory name/file name”.

If the digital copying machine 10 has a function as an FTP (File Transfer Protocol) server and its domain name as a FTP server is “ftp.copier01,” the destination data becomes “ftp://ftp.copier01/guest/doc1.tif”. Therefore, the user can acquire the file doc1.tif, which is located at the directory guest of the HDD 14 by connecting the digital copying machine 10 by means of the FTP connection using the client 20.

Furthermore, if the digital copying machine 10 has a function as an HTTP (Hypertext Transfer Protocol) server, a page describing the image data doc1.tif to be displayed within the Web page, for example, a file in the HTML (hypertext markup language) format, is automatically generated and such a page is given a file name of doc1.tif.htm. In this case, the destination data becomes “http://www.copier01/guest/doc1.tif.htm.”

Therefore, the user of the client 20 is capable of connecting with the digital copying machine 10 using the HTTP, and acquires the file doc1.tif.htm at the directory guest of HDD 14 to display it on the Web browser. Moreover, the user of the client 20 can download the file to a local disk if necessary.

Next, an image processing device according to the second embodiment will be described below.

The digital copying machine 40 shown in FIG. 8 is connected to a client 42 and a file server 43 via a LAN 41. The file server 43 is a computer such as a PC or a workstation similar to the clients 20 and 42, and has a server program installed.

In the second embodiment, the digital copying machine 40 transmits image data to the file server 43 via the LAN 41. In this case, the name of equipment that has a storage device where the image data according to the destination data is stored is assigned with the name of the file server 43. The notation of the destination data becomes, for example, “//fileserver01/guest/doc1.tif.” The digital copying machine 40 outputs an index data sheet, which is a single sheet compilation of one or more pages of image data, reading information, and destination data. Then, the user can grasp the situation that the image data is stored on the storage device of the file server 43, so that the user can acquire the data from the storage device of the file server 43 using the client 42.

While the image data is stored in the storage device of the digital copying machine in the first embodiment, it is stored in the storage device of another equipment connected via the LAN in the second embodiment. Similarly, when the user's computer has a file server function, it is possible to transmit the image data to the storage device of the user's computer to store it there.

Next, an image processing device according to the third embodiment will be described below.

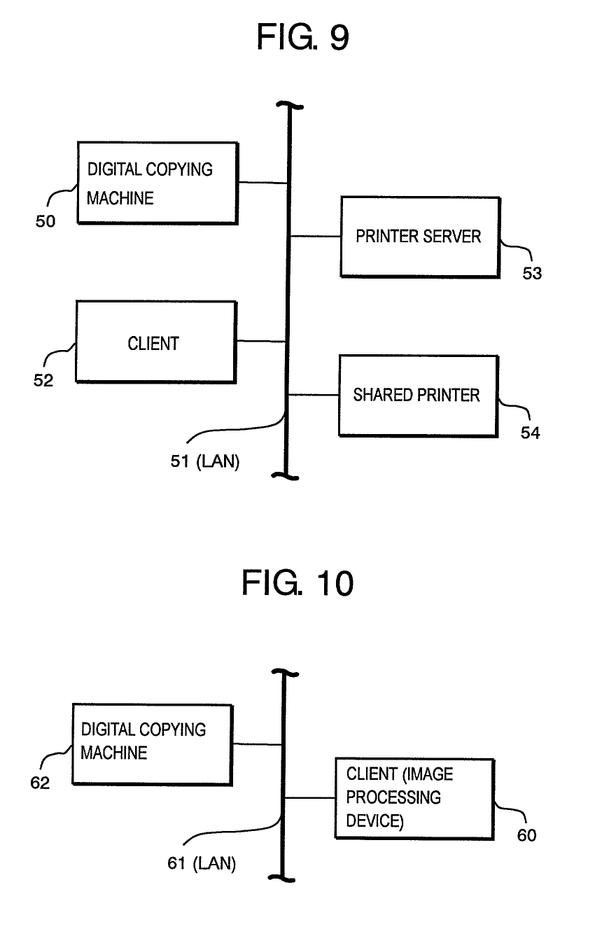

The digital copying machine 50 shown in FIG. 9 is connected to a client 52, a printer server 53, and a shared printer 54 via LAN 51.

The digital copying machine 50 controls the shared printer 54 to print the index data via the printer server 53 in the third embodiment. The image reading function, file server function and printing function of the digital copying machine 10 are used in the first embodiment, while the image reading function and the file server function of the digital copying machine 50 are used in the third embodiment. Thus, the digital copying machine 50 can be viewed as an image reading device with the file server function.

Next, an image processing device concerning the fourth embodiment will be described below.

In the fourth embodiment, a client 60 is connected to a digital copying machine 62 via an LAN 61 as shown in FIG. 10. The client 60 functions as an image processing device by providing the application program by means of a computer-readable storage medium, e.g., CD-ROM, DVD-ROM, and flexible disk, or via a network, and setting up so that it can be executed at the client 60.

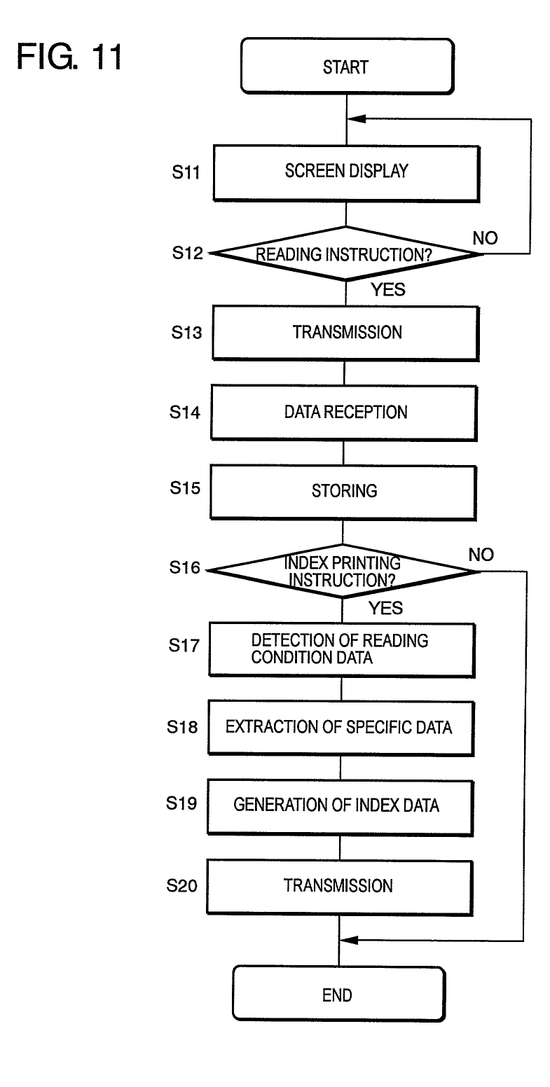

Next, the control of the CPU at the client 60 will be described referring to the flowchart of FIG. 11.

First, the client 60 displays a display similar to the content shown in FIG. 3 on its display unit, and waits for the user's instruction (step S11). Then, it is judged whether the reading instruction exists (steps S12). When it is judged that there is no instruction, the process returns to the step S11 to continue the waiting operation.

When the reading instruction is detected, the client 60 transmits the reading instruction to the digital copying machine 62 (step S13). When it receives the reading instruction, the digital copying machine 62 scans the document to generate the image data, and stores it in the HDD. The digital copying machine 62 transmits the image data and the reading condition data to the client 60.

The client 60 receives the data from the digital copying machine 62 (step S14), and stores it in the HDD (step S15).

Subsequently, when it receives an index printing instruction (step S16: Yes), the client 60 detects the reading condition from the received data (step S17), extracts the image data of the certain page from the received data (step S18), and generates an index data (step S19). Furthermore, the client 60 transmits the index data to the digital copying machine 62 (step S20). The digital copying machine 62 receives the index data and prints it.

It is obvious that this invention is not limited to the particular embodiments shown and described above but may be variously changed and modified without departing from the technical concept of this invention.

Although the first through fourth embodiments are applied in network environments, they are applicable to a standalone environment constituted by connecting a digital copying machine and a computer via a serial interface.

What is claimed is:

1. An image processing device comprising:
an image reader for reading a document image;
a detector for detecting a reading condition in reading the document image;
an extractor for extracting a specific image data from the image data;
a generator for generating an index data including the specific image data and the reading condition data; and
a printer for printing the index data.

2. An image processing device as claimed in claim 1, in which said specific image data is image data of a specified page of the document.

3. An image processing device as claimed in claim 1, in which said reading condition data includes at least one of the items of document size, number of pages, reading mode, resolution, and image quality data.

4. An image processing device as claimed in claim 3, in which said reading condition data includes a name of image data file or destination data of image data.

5. An image processing device as claimed in claim 4, in which said destination data is defined by URL.

6. An image processing device as claimed in claim 1, further comprising a storage device for storing the read image data.

7. An image processing device as claimed in claim 1, further comprising a transmitting device for transmitting the read image data to a computer with a storage device connected thereto via a network.

8. An image data handling system comprising an image input device and a printing device,
in which said image input device comprising:
an image reader for reading a document image;
a detector for detecting a reading condition in reading the document image;
an extractor for extracting a specific image data from the image data;
a generator for generating an index data including the specific image data and the reading condition data; and
a transmitting device for transmitting the index data to said printing device, and
said printing device comprising:
a receiving device for receiving the index data; and
a printer for printing the received index data.

9. An image data handling system as claimed in claim 8, in which said image input device comprises a storage device for storing the read image data.

10. An image data handling system comprising an image input device and a data processing device,
in which said image input device comprising:
an image reader for reading a document image;
a detector for detecting a reading condition in reading the document image;
a transmitting device for transmitting the read image data and the reading condition data to said data processing device; and
a printer for printing the data, and
said data processing device comprising:
a receiving device for receiving the data;
an extractor for extracting a specified image data from the received image data;
a generator for generating an index data including the specified image data and the reading condition data; and
a transmitting device for transmitting the generated index data to said image input device.

11. An image data handling system as claimed in claim 10, in which said image input device comprises a storage device for storing the read image data.

12. A program for executing an image data handling method for handling an image data acquired by reading a document image, in which said image data handling method comprising the steps of:
acquiring the read image data;
acquiring a reading condition data of the document image;
extracting a specific image data from the image data;
generating an index data including the specific image data and the reading condition data; and
issuing instructions to print the index data.

13. A program as claimed in claim 12, in which said reading condition data includes at least one of the items of document size, number of pages, reading mode, resolution, and image quality data.

14. A program as claimed in claim 13, in which said reading condition data includes a name of image data file or destination data of image data.

15. A program as claimed in claim 12, in which said image data handling method further comprises a step of storing the read image data.

16. A program as claimed in claim 12, in which said image data handling method further comprises a step of transmitting the read image data to a computer with a storage device connected thereto via a network.

17. An image data handling method for handling an image data acquired by reading a document image, comprising the steps of:
acquiring the read image data;
acquiring a reading condition data of the document image;
extracting a specific image data from the image data;
generating an index data including the specific image data and the reading condition data; and
issuing instructions to print the index data.

18. An image data handling device comprising:
an input device for inputting an image data;
a storage device for storing the inputted image data;
a generating device for generating an index data by acquiring a generating condition when the image data is generated, generating reduced image data of the image data, and combining the generating condition and the reduced image data; and
an output device for outputting the generated index data.

19. An image data handling device as claimed in claim 18, in which said generating condition data includes at least one of the items of document size, number of pages, reading mode, resolution, and image quality data.

20. An image data handling device as claimed in claim 18, in which said input device is a scanner.

21. An image data handling device as claimed in claim 18, in which said output device is a printer.
